(19) United States
(12) Patent Application Publication
(10) Pub. No.: US 2018/0299948 A1
(43) Pub. Date: Oct. 18, 2018

(54) METHOD FOR COMMUNICATING VIA VIRTUAL SPACE AND SYSTEM FOR EXECUTING THE METHOD

(71) Applicant: COLOPL, Inc., Tokyo (JP)

(72) Inventors: Eita KIKUCHI, Tokyo (JP); Takashi NAKABO, Tokyo (JP)

(21) Appl. No.: 15/881,668

(22) Filed: Jan. 26, 2018

(30) Foreign Application Priority Data
Jan. 27, 2017 (JP) 2017-013102

(51) Int. Cl. G06F 3/01

(52) U.S. Cl. CPC G06F 3/011; G06F 3/017

(57) ABSTRACT

A method includes defining a virtual space and arranging in the virtual space an avatar object. The avatar has a second portion corresponding to a first portion of a user. The method includes detecting a position of the first portion. The method includes moving the second portion to a first position corresponding to the detected position of the first portion. The method includes determining whether the position of the first portion is not identifiable. The method includes moving, in response to a determination that the position of the first portion is not identifiable, the second portion to a second position corresponding to a previously detected position of the first portion. The method includes determining whether detection of the position of the first portion is resumed. The method includes moving the position of the second portion to a third position corresponding position corresponding to a position of the first portion.

### RELATED APPLICATIONS

The present application claims priority to Japanese Application No. 2017-013102, filed Jan. 27, 2017, the disclosure of which is hereby incorporated by reference herein in its entirety.

### TECHNICAL FIELD

This disclosure relates to a technology of controlling an avatar arranged in a virtual space, and more particularly, to a technology of controlling a motion by the avatar.

### BACKGROUND

There is known a technology of providing virtual reality with use of a head-mounted device (HMD). There is proposed a technology of arranging respective avatars of a plurality of users in a virtual space for communication among the plurality of users via those avatars.

In order to promote communication via an avatar in such a virtual space, there has been proposed a technology of translating a motion by a user in a real space to the avatar. Regarding this technology of acquiring a motion by the user in the real space, in Japanese Patent Application Laid-open No. 2008-140101 (Patent Document 1), there is described “an apparatus for acquiring a motion by a human hand in real time without using a marker”.

### PATENT DOCUMENTS

[Patent Document 1] JP 2008-140101 A

### SUMMARY

According to at least one embodiment of this disclosure, there is provided a method including defining a virtual space. The method further includes arranging in the virtual space an avatar representing a user, wherein the avatar comprises a second portion corresponding to a first portion of a real body of the user. The method further includes acquiring data for identifying a position of the first portion in a real space. The method further includes identifying a corresponding position in the virtual space corresponding to the position of the first portion in the real space. The method further includes moving a position of the second portion to the corresponding position based on the data; detecting a first state in which the position of the first portion in the real space is no longer identifiable. The method further includes moving the position of the second portion to the corresponding position corresponding to the data before the first state. The method further includes detecting, after the first state, a second state in which the position of the first portion in the real space is identifiable. The method further includes moving the position of the second portion over a first time to a first position, which is the corresponding position corresponding to the data at a time of the second state.

The above-mentioned and other objects, features, aspects, and advantages of the disclosure may be made clear from the following detailed description of this disclosure, which is to be understood in association with the attached drawings.

### BRIEF DESCRIPTION OF THE DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of a configuration of modules of the computer according to at least one embodiment of this disclosure.

FIG. 15 A diagram of an avatar object of a user of the HMD set according to at least one embodiment of this disclosure.

FIG. 16A A diagram of a user in a real space according to at least one embodiment of this disclosure.

FIG. 16B A diagram of an avatar object included in a field-of-view image of another user according to at least one embodiment of this disclosure.

FIG. 17 A diagram of an operation of a tracking module according to at least one embodiment of this disclosure.

FIG. 18 A table of data forming tracking data according to at least one embodiment of this disclosure.

FIG. 19 A table of data forming tracking data according to at least one embodiment of this disclosure.

FIG. 20 A diagram of a hardware configuration and a module configuration of the server according to at least one embodiment of this disclosure.

FIG. 21 A flowchart of transmission/reception of signals between the computer and the server for translating a motion by the user in the real space in the avatar object according to at least one embodiment of this disclosure.

FIG. 22 A diagram of a case in which the hand of the user is no longer tracked according to at least one embodiment of this disclosure.

FIG. 23 A table of data, which is a history of tracking data at a position of a hand of the user according to at least one embodiment of this disclosure.

FIG. 24 A table of a data structure example of a motion library according to at least one embodiment of this disclosure.

FIG. 25 A flowchart of processing to be executed when the computer is not tracking the position of the hand of the user according to at least one embodiment of this disclosure.

FIG. 26 A diagram of the motion by the avatar object when the position of the hand of the user is no longer tracked according to at least one embodiment of this disclosure.

FIG. 27 A flowchart of processing to be executed when the computer is not tracking the position of the hand of the user according to at least one embodiment of this disclosure.

FIG. 28 A diagram of the motion by the avatar object exhibited when the position of the hand of the user is no longer tracked according to at least one embodiment of this disclosure.

FIG. 29 A diagram of the motion by the avatar object exhibited when the position of the hand of the user is no longer tracked according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

[Configuration of HMD System]

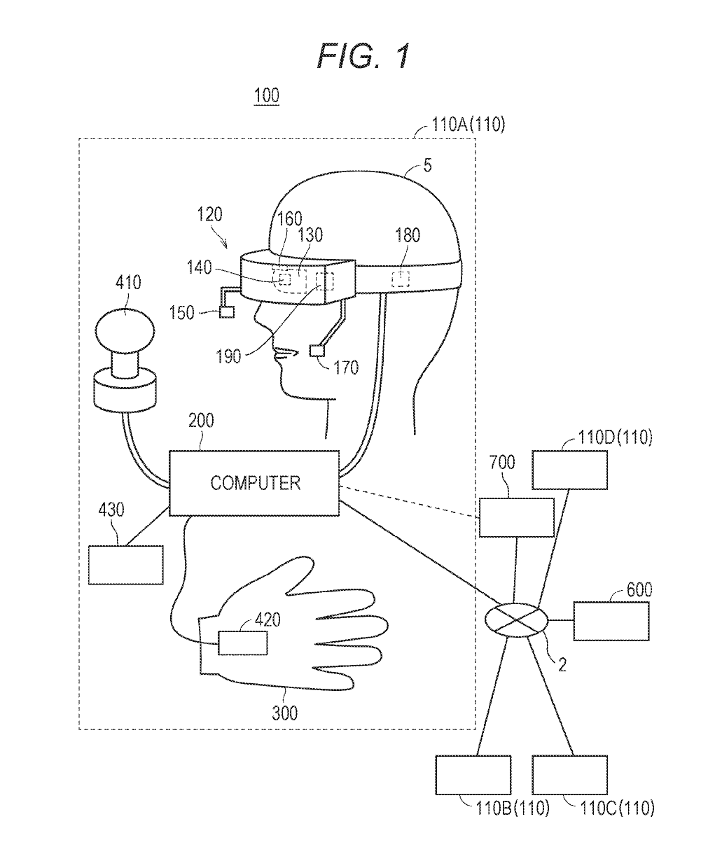

With reference to FIG. 1, a configuration of a head-mounted device (HMD) system 100 is described. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also collectively referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays each of a right-eye image and a left-eye image on the monitor 130. Each eye of the user 5 is able to visually recognize a corresponding image from the right-eye image and the left-eye image so that the user 5 may recognize a three-dimensional image based on the parallax of both of the user' s the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, when the user 5 is able to visually recognize the three-dimensional image displayed by the monitor 130, the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120, or may enable recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In this case, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, for example, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented by a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 is an angular velocity sensor, a geomagnetic sensor, or an acceleration sensor, the HMD 120 uses any or all of those sensors instead of (or in addition to) the HMD sensor 410 to detect the position and the inclination of the HMD 120. As an example, when the sensor 190 is an angular velocity sensor, the angular velocity sensor detects over time the angular velocity about each of three axes of the HMD 120 in the real space. The HMD 120 calculates a temporal change of the angle about each of the three axes of the HMD 120 based on each angular velocity, and further calculates an inclination of the HMD 120 based on the temporal change of the angles.

The eye gaze sensor 140 detects a direction in which the lines of sight of the right eye and the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 photographs a lower part of a face of the user 5. More specifically, the first camera 150 photographs, for example, the nose or mouth of the user 5. The second camera 160 photographs, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and the face of the user 5 is photographed with this single camera.

The microphone 170 converts an utterance of the user 5 into a voice signal (electric signal) for output to the computer 200. The speaker 180 converts the voice signal into a voice for output to the user 5. In at least one embodiment, the speaker 180 converts other signals into audio information provided to the user 5. In at least one aspect, the HMD 120 includes earphones in place of the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body or a part of the clothes of the user 5. In at least one aspect, the controller 300 is configured to output at least any one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented by, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented by a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidently release of the controller 300 in the real space, the controller 300 is mountable on an object like a glove-type object that does not easily fly away by being worn on a hand of the user 5. In at least one aspect, a sensor that is not mountable on the user 5 detects the motion of the hand of the user 5. For example, a signal of a camera that photographs the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. An image to be displayed on the display 430 is not required to be a three-dimensional image, but may be a right-eye image or a left-eye image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

[Hardware Configuration of Computer]

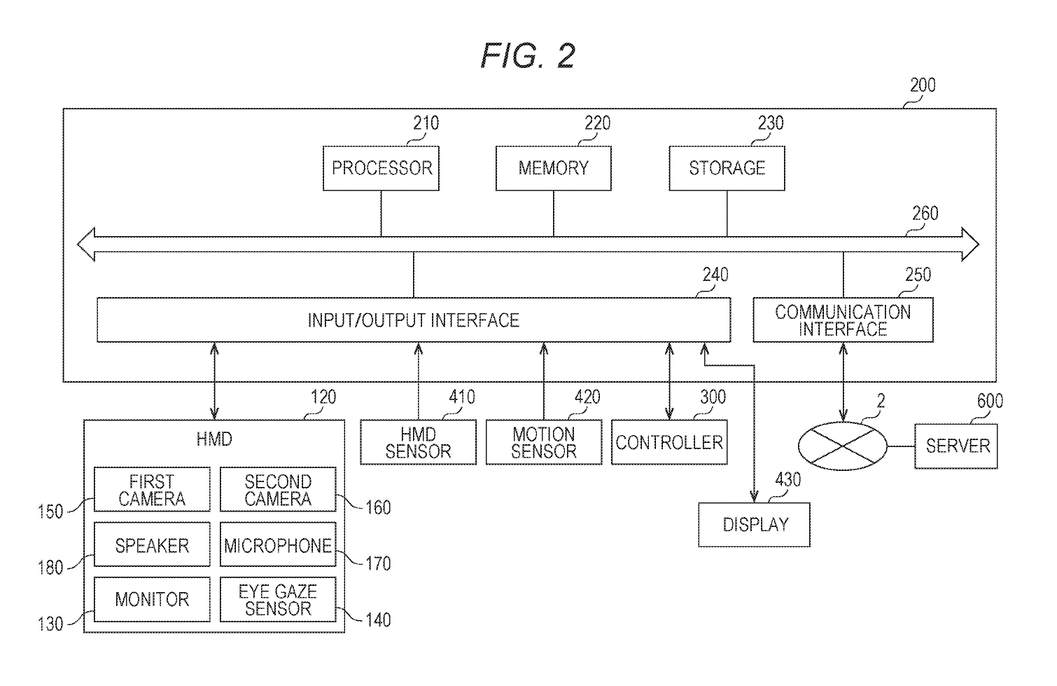

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a condition determined in advance. In at least one aspect, the processor 210 is implemented as a central processing unit (CPU), a graphics processing unit (GPU), a micro-processor unit (MPU), a field-programmable gate array (FPGA), or other devices.

The memory 220 temporarily stores programs and data. The programs are loaded from, for example, the storage 230. The data includes data input to the computer 200 and data generated by the processor 210. In at least one aspect, the memory 220 is implemented as a random access memory (RAM) or other volatile memories.

The storage 230 permanently stores programs and data. In at least one embodiment, the storage 230 stores programs and data for a period of time longer than the memory 220, but not permanently. The storage 230 is implemented as, for example, a read-only memory (ROM), a hard disk device, a flash memory, or other non-volatile storage devices. The programs stored in the storage 230 include programs for providing a virtual space in the system 100, simulation programs, game programs, user authentication programs, and programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth (R), near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

[Uvw Visual-field Coordinate System]

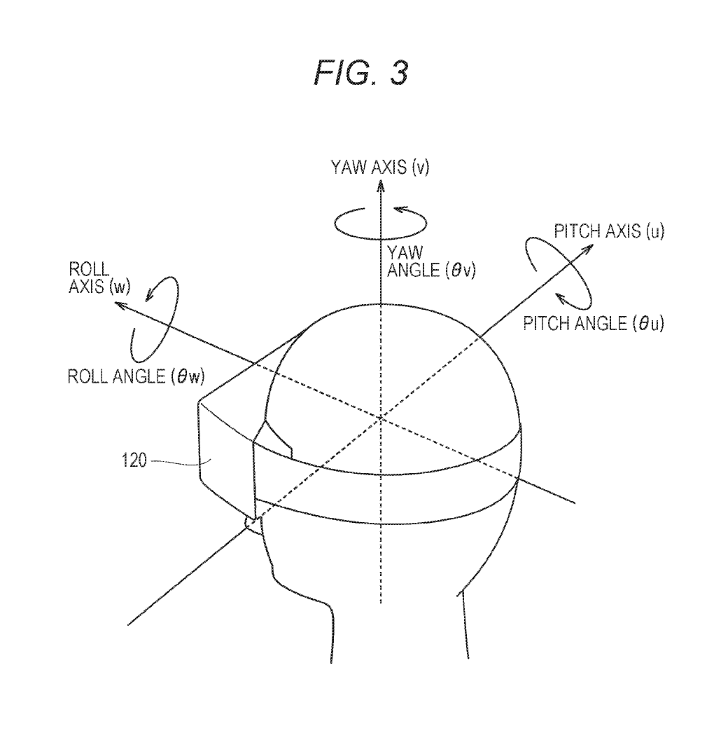

With reference to FIG. 3, the uvw visual-field coordinate system is described. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

[Virtual Space]

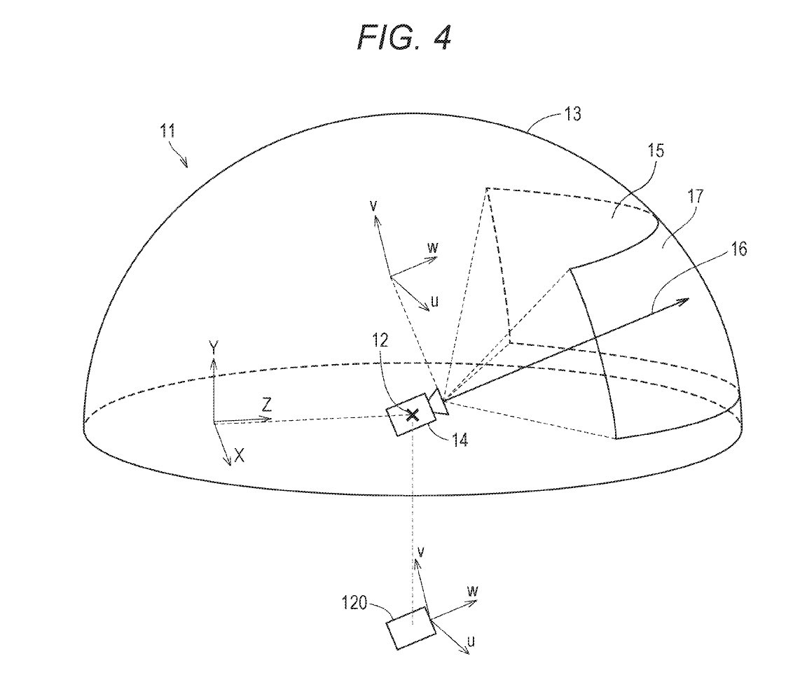

With reference to FIG. 4, the virtual space is further described. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

[User's Line of Sight]

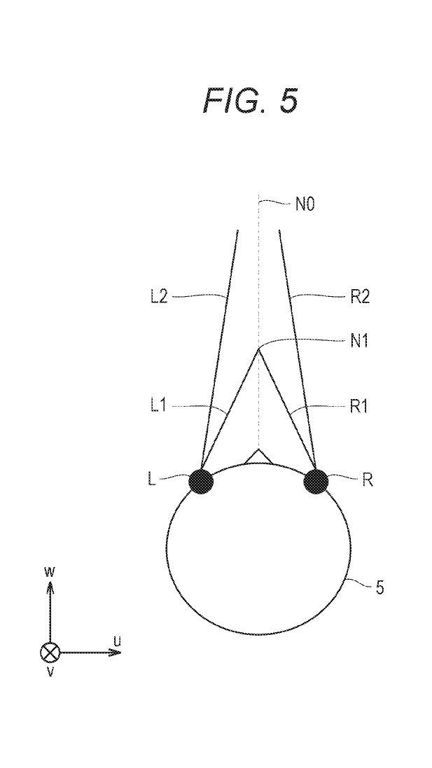

With reference to FIG. 5, determination of the line of sight of the user 5 is described. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

[Field-of-View Region]

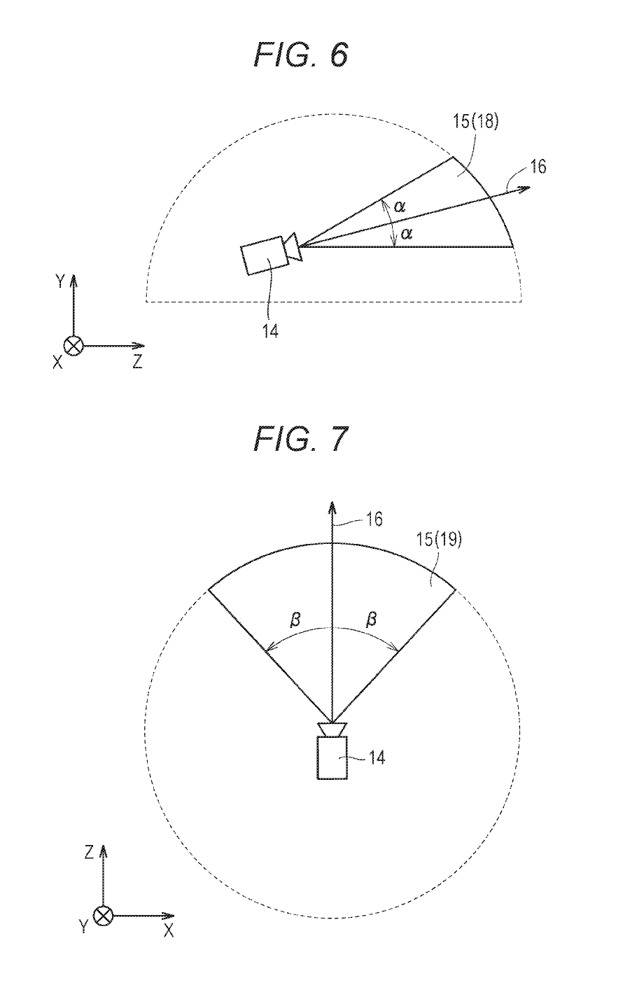

With reference to FIG. 6 and FIG. 7, the field-of-view region 15 is described. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

[Controller]

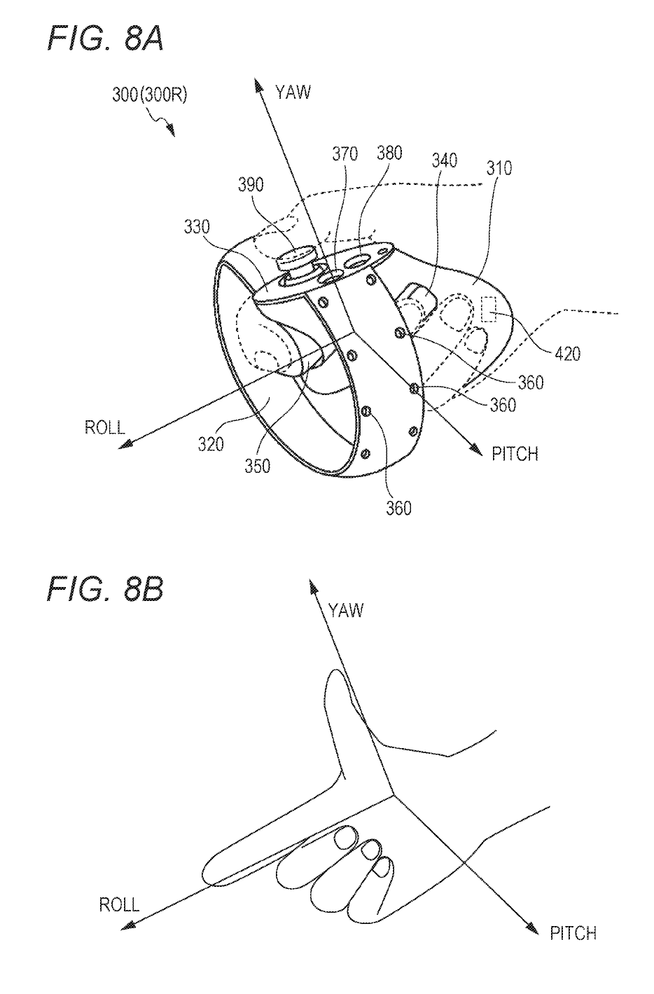

An example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIGS. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

[Hardware Configuration of Server]

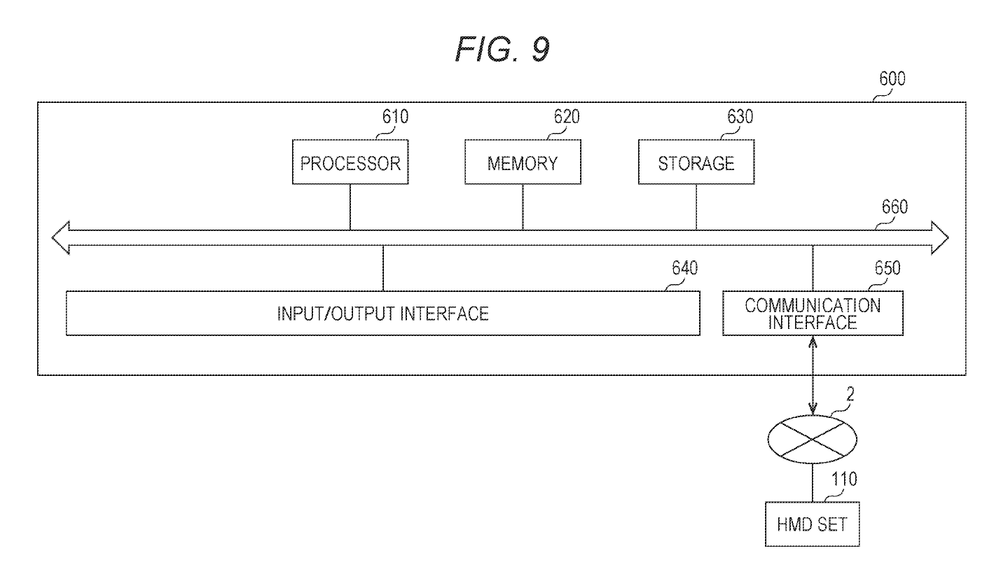

With reference to FIG. 9, the server 600 in at least one embodiment is described. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 temporarily stores programs and data. The programs are loaded from, for example, the storage 630. The data includes data input to the server 600 and data generated by the processor 610. In at least one aspect, the memory 620 is implemented as a random access memory (RAM) or other volatile memories.

The storage 630 permanently stores programs and data. In at least one embodiment, the storage 630 stores programs and data for a period of time longer than the memory 620, but not permanently. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device like a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-Fi, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

[Control Device of HMD]

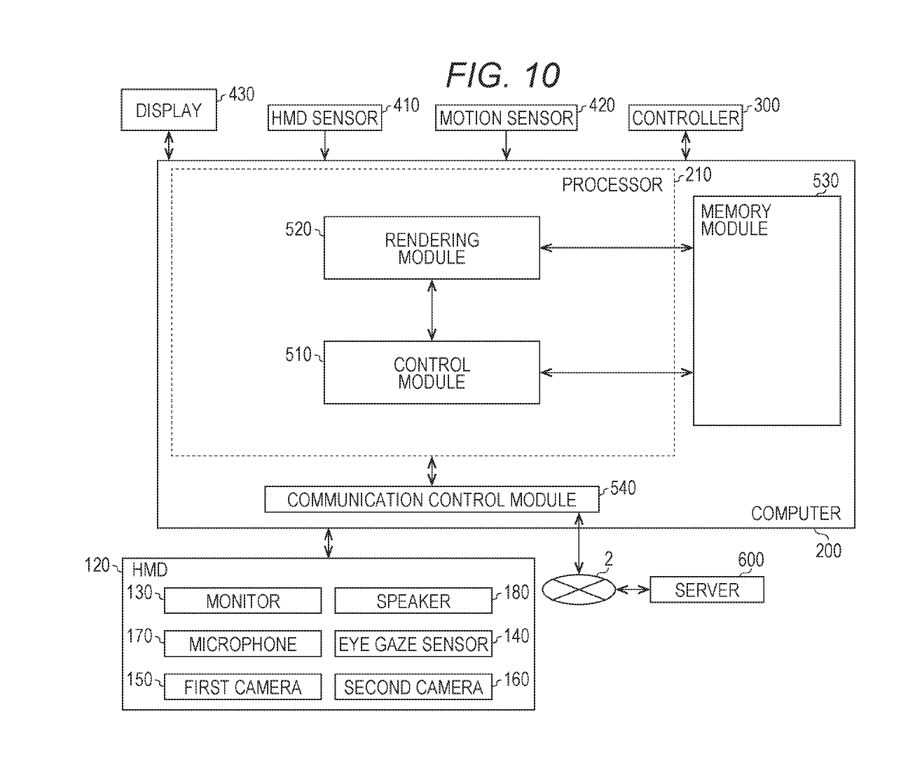

With reference to FIG. 10, the control device of the HMD 120 is described. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity (R) provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may is provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

[Control Structure of HMD System]

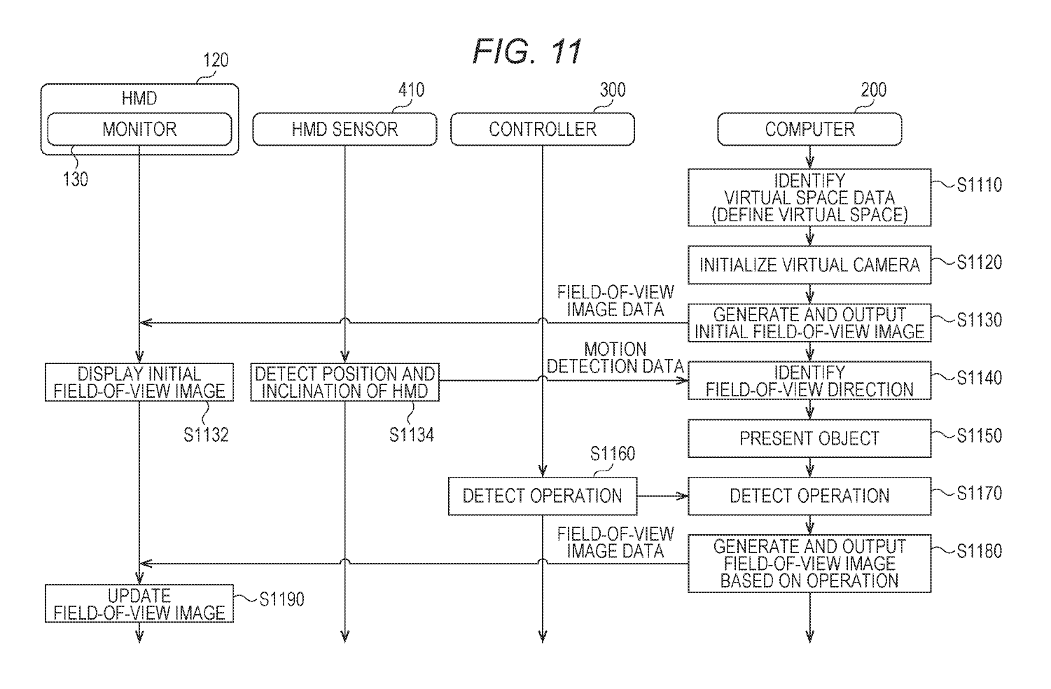

With reference to FIG. 11, the control structure of the HMD set 110 is described. FIG. 11 is a sequence chart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

[Avatar Object]

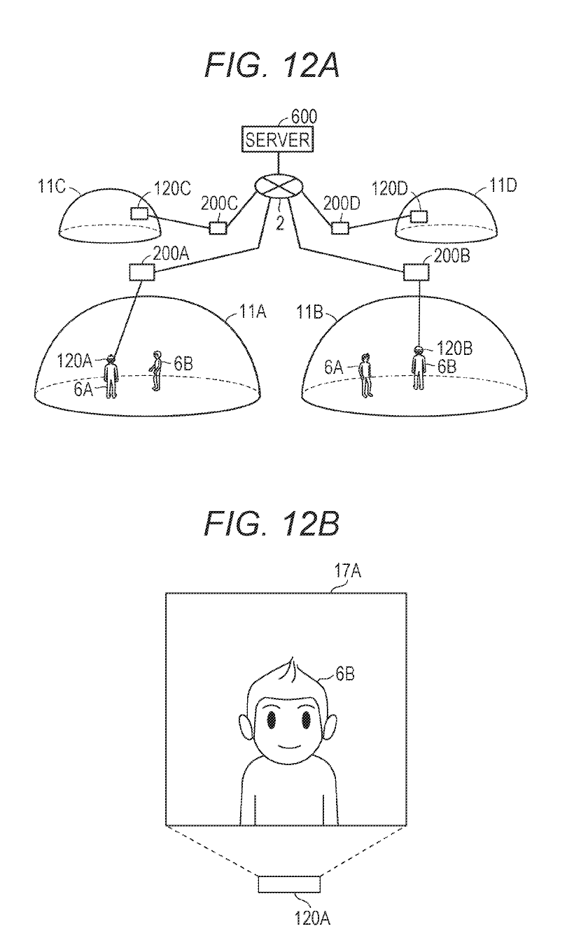

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure . FIG. 12 (B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

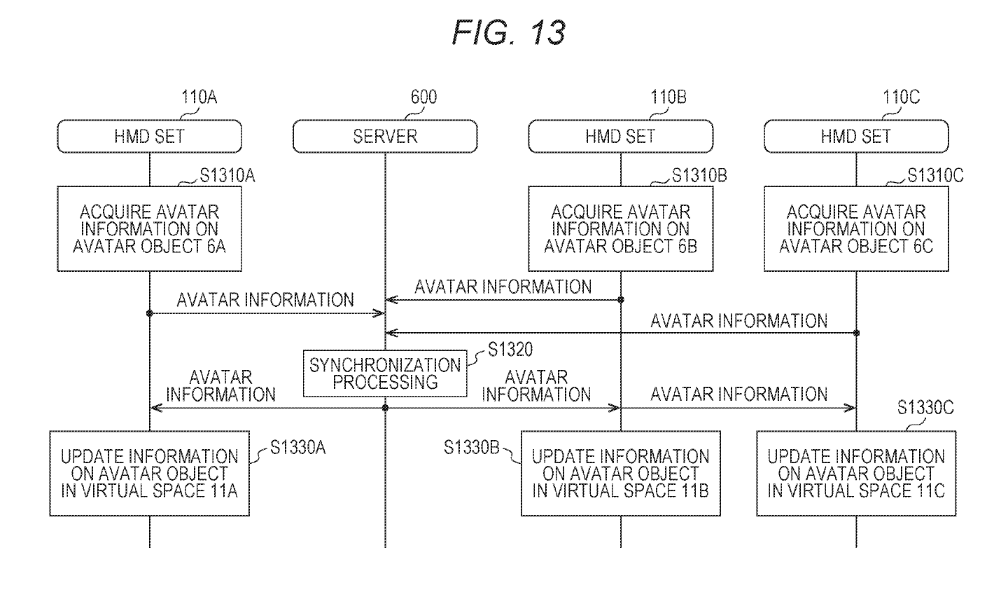

FIG. 13 is a sequence chart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

[Details of Module Configuration]

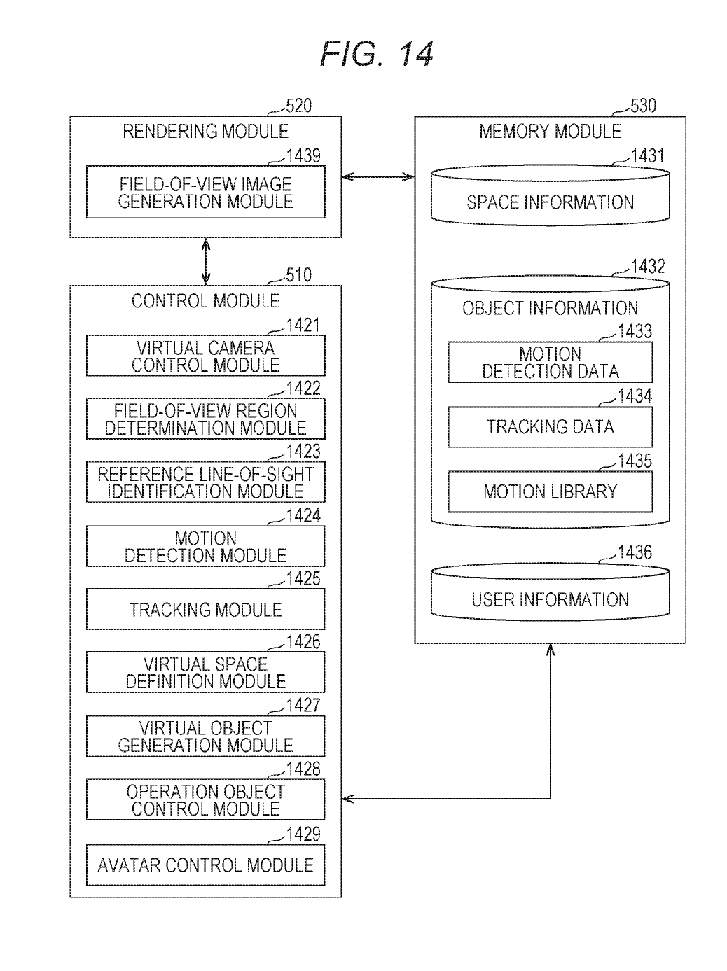

With reference to FIG. 14, a module configuration of the computer 200 are described. FIG. 14 is a block diagram of a configuration of modules of the computer according to at least one embodiment of this disclosure.

[Details of Module Configuration]With reference to FIG. 14, details of a module configuration of the computer 200 are described. FIG. 14 is a block diagram of details of the module configuration of the computer 200 according to at least one embodiment of this disclosure.

In FIG. 14, the control module 510 includes a virtual camera control module 1421, a field-of-view region determination module 1422, a reference line-of-sight identification module 1423, a motion detection module 1424, a tracking module 1425, a virtual space definition module 1426, a virtual object generation module 1427, an operation object control module 1428, and an avatar control module 1429. The rendering module 520 includes a field-of-view image generation module 1439. The memory module 530 stores space information 1431, object information 1432, and user information 1436.

In at least one aspect, the control module 510 controls image display on the monitor 130 of the HMD 120.

The virtual camera control module 1421 arranges the virtual camera 14 in the virtual space 11. The virtual camera control module 1421 controls a position in the virtual space 11 at which the virtual camera 14 is arranged and the direction (inclination) of the virtual camera 14. The field-of-view region determination module 1422 determines the visually-recognized region 15 based on the direction of the head of the user 5 wearing the HMD 120 and the position at which the virtual camera 14 is arranged. The field-of-view image generation module 1439 generates the field-of-view image 17 to be displayed on the monitor 130 based on the determined visually-recognized region 15.

The reference line-of-sight identification module 1423 identifies the line of sight of the user 5 (i.e., inclination of the HMD 120) based on the output from the sensor 190 or the HMD sensor 410. In at least one aspect, the reference line-of-sight identification module 1423 identifies the line of sight of the user 5 based on the signal from the eye gaze sensor 140. The motion detection module 1424 may detect, based on the output from the HMD sensor 410, a displacement amount of the HMD 120 relative to a reference state (e.g., origin in a global coordinate system).

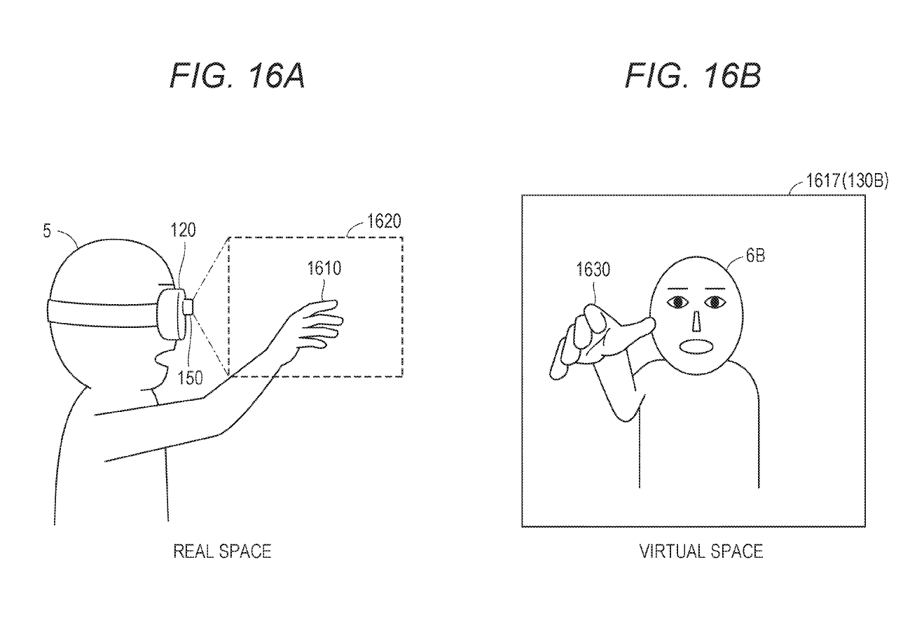

The tracking module 1425 detects (tracks) the position of a part of the body of the user 5. In at least one embodiment, the tracking module 1425 detects, based on depth information input from the first camera 150, the position of the hand of the user 5 in a uvw visual field coordinate system set in the HMD 120. The operation of the tracking module 1425 is described later with reference to FIG. 16A to FIG. 18.

The first camera 150 is capable of acquiring depth information on a target object. As an example, the first camera 150 acquires depth information on a target object in accordance with a time-of-flight (TOF) method. As another example, the first camera 150 acquires depth information on a target object in accordance with a pattern irradiation method. In at least one embodiment of this disclosure, the first camera 150 is a stereo camera capable of photographing a target object from two or more different directions. The first camera 150 may also be a camera capable of photographing infrared rays that are invisible to people. The first camera 150 is mounted on the HMD 120 and photographs a hand of the user. The first camera 150 outputs the acquired hand depth information to the computer 200.

The control module 510 controls the virtual space 11 provided to the user 5. The virtual space definition module 1426 generates virtual space data representing the virtual space 11, to thereby define the virtual space 11 in the system 100.

The virtual object generation module 1427 generates objects to be arranged in the virtual space 11. The objects may include, for example, forests, mountains, other landscapes, and animals to be arranged in accordance with the progression of the story of the game.

The operation object control module 1428 arranges, in the virtual space 11, an operation object for receiving an operation of the user in the virtual space 11. The user operates the operation object to operate an object arranged in the virtual space 11, for example. In at least one aspect, the operation object includes, for example, a hand object corresponding to the hand of the user wearing the HMD 120. In at least one aspect, the operation object corresponds to a hand portion of an avatar object described later.

The avatar control module 1429 generates data for arranging an avatar object of the user of another computer 200, which is connected via the network, in the virtual space 11. In at least one aspect, the avatar control module 1429 generates data for arranging an avatar object of the user 5 in the virtual space 11. In at least one aspect, the avatar control module 1429 generates an avatar object simulating the user 5 based on an image including the user 5. In at least one aspect, the avatar control module 1429 generates data for arranging in the virtual space 11 an avatar object that is selected by the user 5 from among a plurality of types of avatar objects (e.g., objects simulating animals or objects of deformed humans).

The avatar control module 1429 translates the motion of the HMD 120 in the avatar object based on the output from the sensor 190 or the HMD sensor 410. For example, the avatar control module 1429 detects that the HMD 120 has inclined based on the output from the sensor 190, and generates data for arranging the avatar object in an inclined manner. The avatar control module 1429 translates, based on the output from the tracking module 1425, the motion by the hand of the user in the real space in the hand of the avatar object. The avatar control module 1429 controls the motion by the avatar object corresponding to the user of another computer 200 based on data input from the computer 200.

The space information 1431 stores one or more templates that are defined to provide the virtual space 11.

The object information 1432 stores content to be reproduced in the virtual space 11, objects to be used in the content, and information (e.g., positional information) for arranging objects in the virtual space 11. The content may include, for example, game content and content representing landscapes that resemble those of the real society.

The object information 1432 includes motion detection data 1433, tracking data 1434, and a motion library 1435. The motion detection data 1433 is data representing the output from the sensor 190, that is, the inclination of the HMD 120. In at least one aspect, the motion detection data 1433 is data representing the output from the HMD sensor 410, that is, the position and inclination of the HMD 120. The tracking data 1434 is data representing the position of the hand of the user 5 acquired by the first camera 150 and the tracking module 1425. The motion library 1435 stores the position of the hand of the user 5 and the motion of the hand of the avatar object in association with each other.

The user information 1436 stores a program for causing the computer 200 to function as a control apparatus for the system 100, application programs using various types of content stored in the object information 1432, and the like.

[Avatar Object]

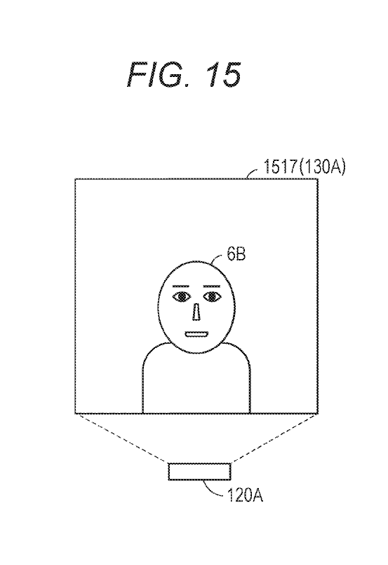

An avatar object in at least one embodiment is now described with reference to FIG. 15.

In at least one aspect, a virtual camera control module 1421A arranges the virtual camera 14A imaging the field-of-view image 17A of the user 5A at the position of the eyes of the avatar object 6A.

FIG. 15 is a view of the field-of-view region 1517 of the user 5A according to at least one embodiment of this disclosure. The field-of-view region 1517 is an image displayed on a monitor 130A of the HMD 120A. This field-of-view region 1517 is an image generated by the virtual camera 14A. The avatar object 6B corresponding to the user 5B is displayed in the field-of-view region 1517. Although not in FIG. 15, the avatar object 6A of the user 5A is similarly displayed in the field-of-view image of the user 5B.

Under the state of FIG. 15, the user 5A is able to communicate to/from the user 5B via the virtual space through conversation. More specifically, voice data of the user 5A acquired by a microphone 170A is transmitted to the HMD 120B of the user 5B via the server 600 and output from a speaker 180B provided on the HMD 120B. Voice data of the user 5B is transmitted to the HMD 120A of the user 5A via the server 600, and output from a speaker 180A provided on the HMD 120A.

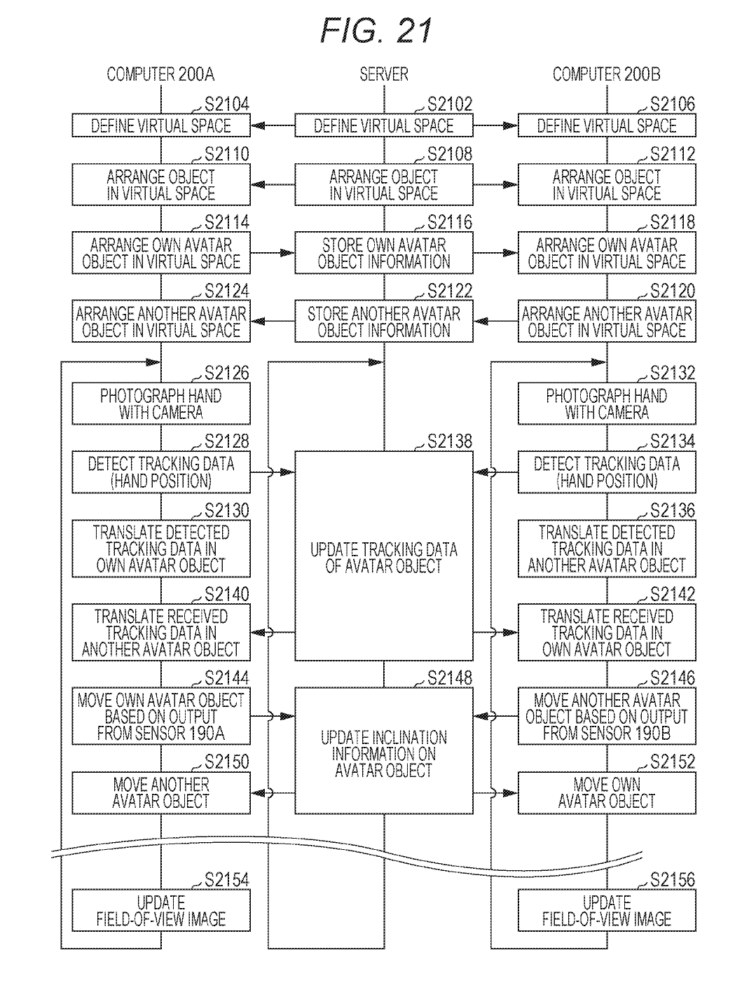

As described later with reference to FIG. 21, a motion by the user 5B (motion by HMD 120B and motion by hand of user 5B) is translated in the avatar object 6B by the avatar control module 1429A. With this, the user 5A is able to recognize the motion by the user 5B through the avatar object 6B.

[Hand Tracking]

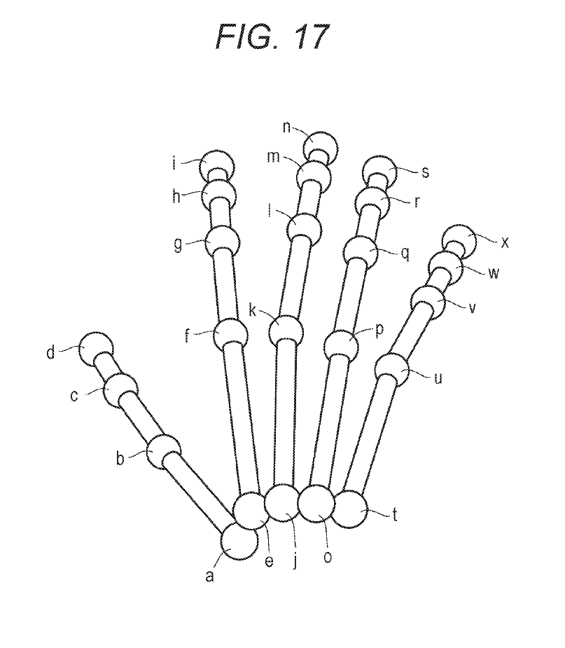

Processing for tracking a hand motion is now described with reference to FIG. 16A, FIG. 16B, FIG. 17, and FIG. 18. FIG. 16A and FIG. 16B are diagrams of processing for tracking the hand of the user 5B according to at least one embodiment of this disclosure. In FIG. 16A, the user 5B is in the real space. In FIG. 16B, the avatar object 6B is included in a field-of-view image 1617 of the user 5A.

In FIG. 16A, the user 5B is wearing the HMD 120B in the real space. The first camera 150B is mounted to the HMD 120B. The first camera 150B acquires depth information on an object included in a space 1620 in front of the HMD 120B. In at least the example in FIG. 16A, the first camera 150B acquires depth information on a hand 1610 of the user 5B included in the space 1620.

A tracking module 1425B acquires positional information on the hand 1610 of the user 5B based on the depth information. The first camera 150B is mounted to the HMD 120B, and hence the positional information on the hand 1610 may represent the position in the uvw visual-field coordinate system set in the HMD 120B. The computer 200B transmits this positional information as tracking data to the computer 200A via the server 600.

In FIG. 16B, the processor 210A of the computer 200A serving as the avatar control module 1429A to cause a hand 1630 of the avatar object 6B arranged in the virtual space 11A to follow a position derived from the received tracking data. As at least one example, the processor 210A converts the position indicated by the received tracking data (position of the uvw visual-field coordinate system set in the HMD 120B) into the position of the XYZ coordinate system based on the position of the head of the avatar object 6B. The processor 210A moves the hand 1630 of the avatar object 6B to the converted position. In this way, the motion of the hand of the user 5B is translated in the avatar object 6B visually recognized by the user 5A.

FIG. 17 is a diagram of an operation of the tracking module 1425 according to at least one embodiment of this disclosure. The tracking module 1425 tracks the motion of the bones of the hand of the user 5 based on the depth information of the hand input from the first camera 150. In at least the example in FIG. 17, the tracking module 1425 detects the position of each of joints a, b, c, . . . , x of the hand of the user 5.

The tracking module 1425 is capable of recognizing a shape (finger motion) of the hand of the user 5 based on the positional relationship among the joints a to x. The tracking module 1425 is able to recognize, for example, that the hand of the user 5 is pointing with a finger, that the hand is open, that the hand is closed, that the hand is performing a motion of grasping something, and that the hand is twisted. The tracking module 1425 is also able to determine whether the recognized hand is a left hand or a right hand based on the positional relationship among the joints a to d and other joints. Such a first camera 150 and tracking module 1425 can be implemented by, for example, Leap Motion (R) provided by Leap Motion, Inc.

In FIG. 18, there is data 1841 forming the tracking data 1434. The tracking module 1425 acquires, for each of the joints a to x, data 1841, which is positional information in the uvw visual-field coordinate system set in the HMD 120. The computer 200 stores the acquired data 1841 in the memory 220 as tracking data 1434. The computer 200 also transmits, via the server 600, the acquired data 1841 to another computer 200 sharing the virtual space 11. For example, when the computer 200A has received data 1841 from the computer 200B, the computer 200A is able to move the shape of the hand of the avatar object 6B in accordance with the data 1841.

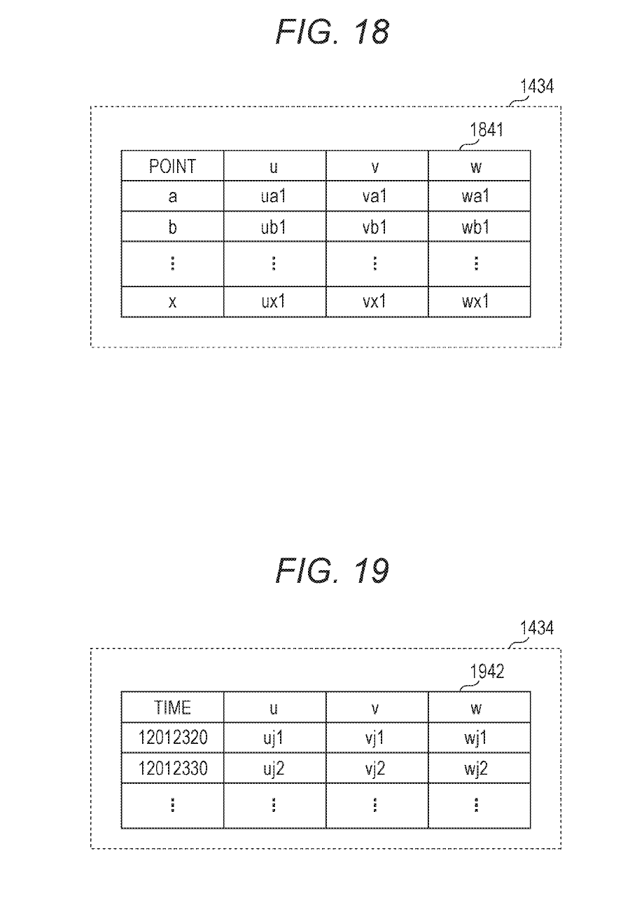

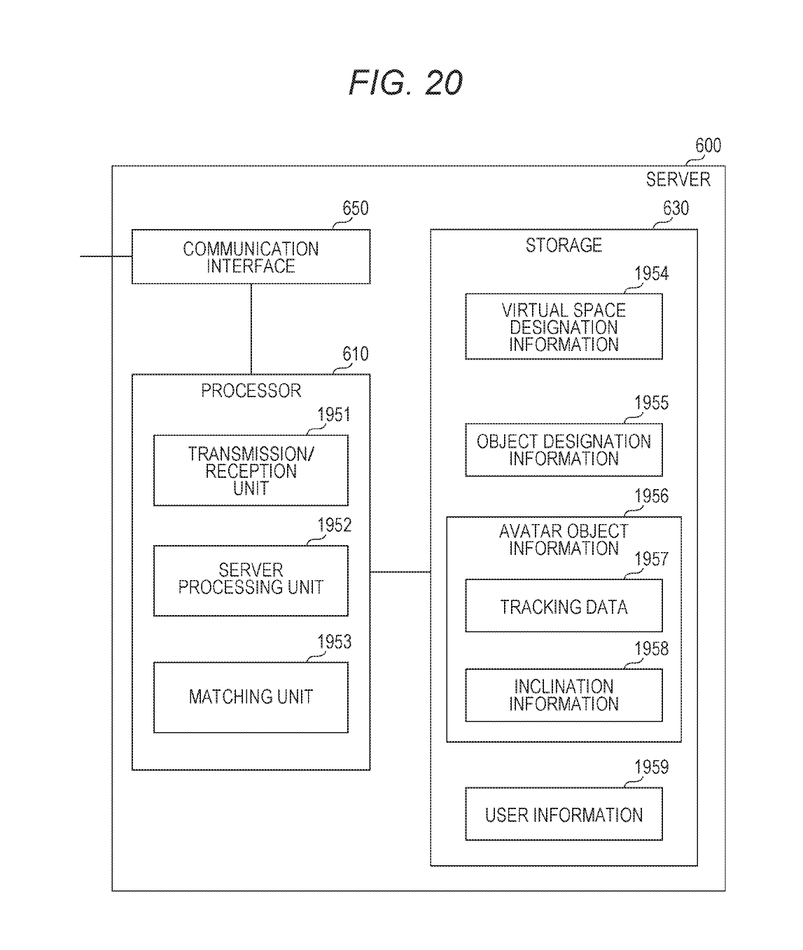

In FIG. 19, there is data 1942 forming the tracking data 1434. As at least one example, the computer 200 recognizes, of the joints a to x, the joint j as a representative position of the hand of the user 5. In the data 1942, there is shown a history over a predetermined period (e.g., 10 seconds) at the position of the hand (position of joint j) of the user 5.

The computer 200 stores in the memory 220 the data 1942 representing the position of the hand of the user 5 wearing the HMD 120 connected to the computer 200. The computer 200 also stores in the memory 220 the data 1942 representing the position of the hand of the user 5 of another computer 200 based on the data 1841 received from the another computer 200. As a specific example, the computer 200A stores in the memory 220A the data 1942 representing the position of the hand of the user 5A, and also stores in the memory 220A the data 1942 representing the position of the hand of the user 5B based on the data 1841 received from the computer 200B.

FIG. 20 is a diagram of a hardware configuration and a module configuration of the server 600 according to at least one embodiment of this disclosure. In at least one embodiment of this disclosure, the server 600 includes, as components, the communication interface 650, the processor 610, and the storage 630.

The communication interface 650 functions as a communication module for wireless communication, which is configured to perform, for example, modulation/demodulation processing for transmitting/receiving signals to/from an external communication device, for example, the computer 200. The communication interface 650 is implemented by, for example, a tuner or a high frequency circuit.

The processor 610 controls operation of the server 600. The processor 610 executes various control programs stored in the storage 630 to function as a transmission/reception unit 1951, a server processing unit 1952, and a matching unit 1953.

The transmission/reception unit 1951 transmits/receives various kinds of information to/from each computer 200. For example, the transmission/reception unit 1951 transmits to each computer 200 a request for arranging objects in the virtual space 11, a request for deleting objects from the virtual space 11, a request for moving objects, voices of the user, or information for defining the virtual space 11.

The server processing unit 1952 performs processing required for a plurality of users to share the same virtual space 11. For example, the server processing unit 1952 updates avatar object information 1956 described later based on the information received from the computer 200.

The matching unit 1953 performs a series of processing steps for associating a plurality of users with one another. For example, when an input operation for the plurality of users to share the same virtual space 11 is performed, the matching unit 1953 performs, for example, processing of associating users belonging to the virtual space 11 to one another.

The storage 630 stores virtual space designation information 1954, object designation information 1955, the avatar object information 1956, and user information 1959.

The virtual space designation information 1954 is information to be used by the virtual space definition module 1426 of the computer 200 to define the virtual space 11. For example, the virtual space designation information 1954 contains information for designating the size of the virtual space 11 and content to be developed in each mesh forming the virtual space 11.

The object designation information 1955 designates an object to be arranged (generated) by the virtual object generation module 1427 of the computer 200 in the virtual space 11.

The avatar object information 1956 includes tracking data 1957 and inclination information 1958. The tracking data 1957 is information representing the position of the hand of each avatar object in the virtual space 11. The inclination information 1958 represents an inclination of each avatar object in the virtual space 11. The avatar object information 1956 is updated as appropriate based on information input from the computer 200.

The user information 1959 is information on the user 5 of the computer 200. The user information 1959 contains, for example, identification information (e.g., user account) identifying the plurality of users 5.

[Control for Translating Operation of User in Avatar Object]

With reference to FIG. 21, a method of controlling operation of an avatar object in the virtual space is described. FIG. 21 is a flowchart of exchange of signals between the computer 200 and the server 600 for translating a motion by the user in the real space in the avatar object according to at least one embodiment of this disclosure. The processing in FIG. 21 may be implemented by the processor 210 of the computer 200 executing a control program stored in the memory 220 or the storage 230 and the processor 610 of the server 600 executing a control program stored in the storage 630.

In Step S2102, the processor 610 of the server 600 serves as the transmission/reception unit 1951 to transmit the virtual space designation information 1954 to the computers 200A and 200B based on requests for generating the virtual space, which are received from the computers 200A and 200B. At this time, each computer 200 may transmit identification information on the user 5 to the server 600 together with the virtual space designation information 1954. Then, the processor 610 may serve as the matching unit 1953 to associate pieces of identification information on the users 5A and 5B with each other to establish the fact that the users 5A and 5B share the same virtual space.

In Step S2104, the processor 210A of the computer 200A serves as a virtual space definition module 1426A to define the virtual space 11A based on the received virtual space designation information 1954. In Step S2106, similarly to the processor 210A, the processor 210B of the computer 200B defines the virtual space 11B.

In Step S2108, the processor 610 outputs the object designation information 1955 for designating objects to be arranged in the virtual spaces 11A and 11B to the computers 200A and 200B.

In Step S2110, the processor 210A serves as a virtual object generation module 1427A to arrange objects in the virtual space 11A based on the received object designation information 1955. In Step S2112, the processor 210B arranges objects in the virtual space 11B similarly to the processor 210A.

In Step S2114, the processor 210A serves as an avatar control module 1429A to arrange the avatar object 6A (denoted by “own avatar object” in FIG. 21) of the user 5A himself or herself in the virtual space 11A. Then, the processor 210A transmits information (e.g., data for modeling and positional information) on the avatar object 6A to the server 600.

In Step S2116, the processor 610 stores the received information on the avatar object 6A into the storage 630 (avatar object information 1956). The processor 610 further transmits the information on the avatar object 6A to the computer 200B sharing the same virtual space with the computer 200A.

In Step S2118, the processor 210B serves as an avatar control module 1429B to arrange the avatar object 6A in the virtual space 11B based on the received information on the avatar object 6A.

Similarly to Step S2114 to Step S2118, in Step S2120 to Step S2124, the avatar object 6B is generated in the virtual spaces 11A and 2B (denoted by “another avatar object” in FIG. 21), and information on the avatar object 6B is stored in the storage 630.

In Step S2126, the processor 210A images the hand of the user 5A with the first camera 150A to acquire depth information.

In Step S2128, the processor 210A serves as the tracking module 1425A to detect tracking data representing the position of the hand of the user 5A based on the acquired depth information. The processor 210A transmits the detected tracking data to the server 600.

In Step S2130, the processor 210A serves as the avatar control module 1429A to translate the detected tracking data in the avatar object 6A arranged in the virtual space 11A. As a result, the hand of the avatar object 6A moves to the position indicated by the tracking data.

In Step S2132 to Step S2136, in the same manner as in Step S2126 to Step S2130, the processor 210B detects tracking data representing the position of the hand of the user 5B, and transmits that data to the server 600. The processor 210B translates the data in the avatar object 6B arranged in the virtual space 11B.

In Step S2138, the processor 610 serves as the server processing unit 1952 to update the tracking data 1957 corresponding to the avatar object 6A based on the tracking data received from the computer 200A. The processor 610 further updates the tracking data 1957 corresponding to the avatar object 6B based on the tracking data received from the computer 200B.

In Step S2138, the processor 610 further serves as the transmission/reception unit 1951 to transmit the tracking data received from the computer 200A to the computer 200B. The processor 610 transmits the tracking data received from the computer 200B to the computer 200A.

In Step S2140, the processor 210A translates the tracking data received from the server 600 in the avatar object 6B arranged in the virtual space 11A. As a result, the hand of the avatar object 6B moves together with the motion by the user 5B in the real space.

In Step S2142, the processor 210B translates the tracking data received from the server 600 in the avatar object 6A arranged in the virtual space 11B. As a result, the hand of the avatar object 6A moves together with the motion by the user 5A in the real space.

In Step S2144, the processor 210A detects the inclination of the HMD 120A based on the output from the sensor 190A. The processor 210A changes the inclination of the avatar object 6A arranged in the virtual space 11A so as to move together with the inclination of the HMD 120A. The processor 210A transmits to the server 600 motion detection data representing the detected inclination of the HMD 120A.

In Step S2146, the processor 210B changes the inclination of the avatar object 6B arranged in the virtual space 11B based on the output from the sensor 5B. The processor 210B transmits to the server 600 motion detection data corresponding to the output from the sensor 5B.

In Step S2148, the processor 610 serves as the server processing unit 1952 to update the inclination information 1958 corresponding to the avatar object 6A based on the motion detection data received from the computer 200A. The processor 610 further updates the inclination information 1958 corresponding to the avatar object 6B based on the motion detection data received from the computer 200B.

In Step S2148, the processor 610 further serves as the transmission/reception unit 1951 to transmit the motion detection data from the computer 200A to the computer 200B. The processor 610 transmits the motion detection data received from the computer 200B to the computer 200A.

In Step S2150, the processor 210A changes the inclination of the avatar object 6B arranged in the virtual space 11A based on the received motion detection data. In Step S2152, the processor 210B changes the inclination of the avatar object 6A arranged in the virtual space 11B based on the received motion detection data.

In Step S2154, the processor 210A displays, on the monitor 130A, an image photographed by the virtual camera 14A arranged at the position of the eyes of the avatar object 6A. As a result, a field-of-view image visually recognized by the user 5A is updated. After that, the processor 210A returns the processing to Step S2126.

In Step S2156, similarly to the processor 210A, the processor 210B displays an image photographed by the virtual camera 14B on the monitor 130B. As a result, a field-of-view image visually recognized by the user 5B is updated. After that, the processor 210B returns the processing to Step S2132.

In at least one embodiment of this disclosure, the processing of Step S2126 to Step S2156 is executed repeatedly at an interval of, e.g., 1/60 second or 1/30 second.

Through the above-mentioned series of processing steps, the user 5 is able to recognize in the virtual space 11 a motion by another user in the real space via the avatar object of the another user. Therefore, the user 5 feels the avatar object to be much more human-like. As a result, communication in the virtual space via the avatar object can be promoted.

In at least one aspect, the above-mentioned repeatedly executed processing includes processing of enhancing communication between users in the virtual space 11, for example, processing of transmitting voices of the user 5 to the computer 200 of the partner.

In the example described above, in Step S2114 and in Step S2120, the computer 200 arranges the own avatar object of the user in the virtual space 11. However, in at least one aspect, the processing in Step S2114 and in Step S2120 is omitted. This is because the user is able to communicate to/from a partner as long as the avatar object of the partner is arranged in the virtual space 11.

[Processing to be Executed When Tracking Is No Longer Possible]

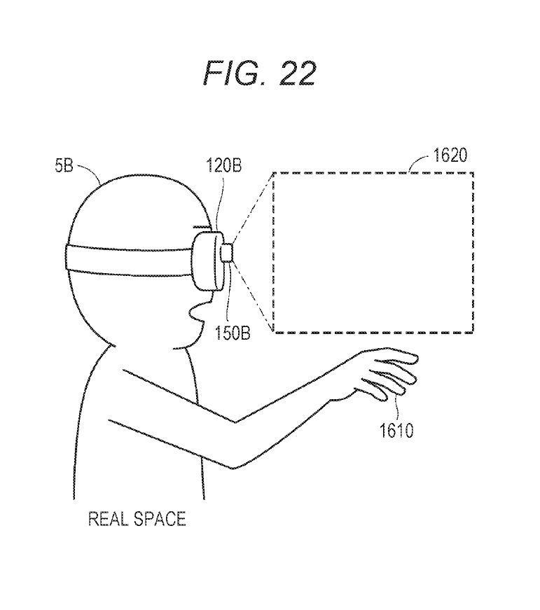

Control of the motion of the hand of the avatar object to be executed when the motion of the hand is no longer tracked is now described with reference to FIG. 22. FIG. 22 is a diagram of a case in which the hand of the user 5B is no longer tracked according to at least one embodiment of this disclosure.

In FIG. 22, the hand 1610 of the user 5B is outside the space 1620, which is the depth detection range of the first camera 150B. Therefore, the first camera 150B does not acquire depth information on the hand 1610.

In addition to the example in FIG. 22, the first camera 150B does not acquire the depth information on the hand 1610 when there is some kind of obstacle between the first camera 150B and the hand 1610, or when the motion of the hand 1610 is too fast.

When the depth information on the hand of the user 5B is no longer acquired (i.e., position of hand is no longer acquired) by the first camera 150B, the tracking module 1425B outputs to the server 600 a tracking failure signal indicating that fact. The server 600 transmits the tracking failure signal to the computer 200A sharing the virtual space with the computer 200B.

When the depth information on the hand of the user 5B is again acquired by the first camera 150B, the tracking module 1425B outputs the tracking data representing the positions of the joints a to x to the computer 200A via the server 600.

In FIG. 23, there is data 1942, which is a history of the tracking data of the position of the hand (position of joint j) of the user 5B. The data 1942 in FIG. 23 is stored in the memory 220A of the computer 200A. Specifically, this data 1942 is a part of the tracking data received from the computer 200B via the server 600.

In at least the example shown in FIG. 23, after receiving tracking data 2361 at a time “12012330”, the computer 200A receives a tracking failure signal from the computer 200B. Therefore, this tracking data 2361 is data (hereinafter also referred to as “preceding tracking data”) immediately preceding the time at which the position of the hand of the user 5B is no longer tracked.

The computer 200A receives from the computer 200B tracking data 2362 representing the position of the hand of the user 5B at a time “12012450”. Therefore, this tracking data 2362 is data (hereinafter also referred to as “tracking data after resumption”) after resumption of a state in which the computer 200B is again capable of tracking the position of the hand of the user 5B.

In response to receiving the tracking failure signal from the computer 200B, the processor 210A moves the hand of the avatar object 6B based on the preceding tracking data 2361.

More specifically, the processor 210A refers to the motion library 1435 and identifies the motion corresponding to the preceding tracking data 2361. Then, the processor 210A moves the hand of avatar object 6B to the position indicated by the preceding tracking data 2361 in accordance with the identified motion.

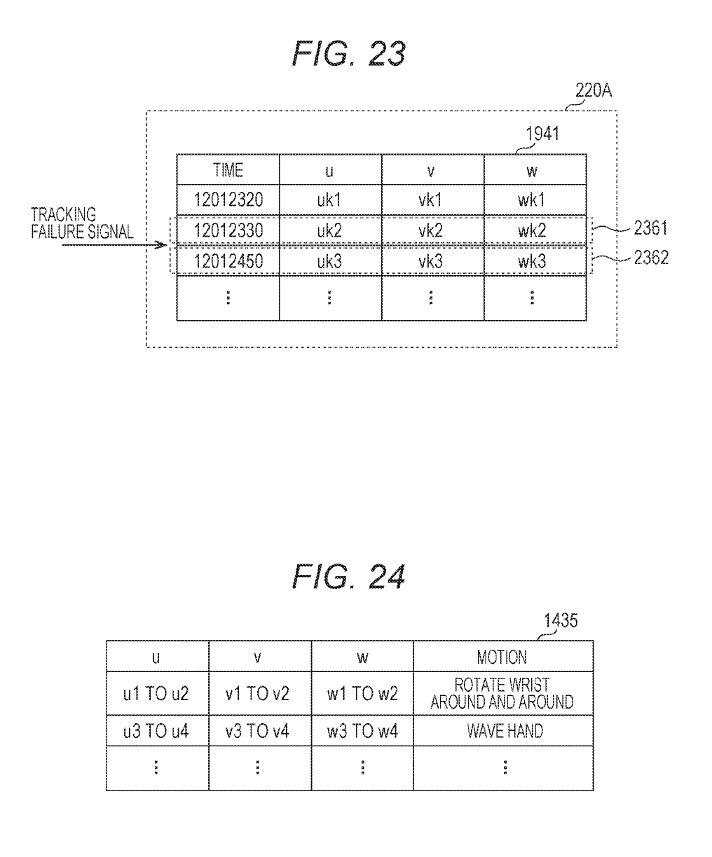

In FIG. 24, there is a data structure example of the motion library 1435. The motion library 1435 stores the spatial region in the uvw visual-field coordinate system and the motion by the avatar object 6 in association with each other.

In at least the example shown in FIG. 24, when the position indicated by the preceding tracking data 2361 is included in a spatial region of (u, v, w)=(u1 to u2, v1 to v2, w1 to w2), the processor 210A executes a motion for rotating the wrist of the avatar object 6B around and around. When the position indicated by the preceding tracking data 2361 is included in a spatial region of (u, v, w)=(u3 to u4, v3 to v4, w3 to w4), the processor 210A executes a motion for waving the hand of the avatar object 6B.

In FIG. 24, the motions “rotate wrist around and around” and “wave hand” are some examples of the motion, but in actual practice, the data required for executing those motions is stored in the motion library 1435.

In at least one aspect, the spatial region of (u, v, w)=(u1 to u2, v1 to v2, w1 to w2) is set as a spatial region above the first camera 150B (head of user 5B), and the spatial region of (u, v, w)=(u3 to u4, v3 to v4, w3 to w4) is set as a spatial region below the first camera 150 B.

In at least the example described above, even when the computer 200A is no longer tracking the position of the hand of the user 5B, the avatar object 6B is able to perform a natural motion in the virtual space 11A. Therefore, the user 5A is able to continue communication to/from the user 5B without feeling strange about the avatar object 6B.

When the position of the hand of the user 5B has returned to a position from which the hand is again tracked (in response to reception of tracking data after resumption 2362), the processor 210A moves the hand of the avatar object 6B over a predetermined time to the position indicated by the tracking data 2362.

In at least one aspect, the processor 210A moves the hand of avatar object 6B at a speed determined in advance. In at least one aspect, the processor 210A moves the hand of the avatar object 6B at a speed corresponding to a distance between the hand position of the avatar object 6B at a timing when the tracking data after resumption 2362 is received and the position indicated by the tracking data 2362. As at least one example, the processor 210A moves the hand of avatar object 6B faster when this distance is longer. In at least one aspect, the processor 210A gradually reduces the movement speed of the hand of the avatar object 6B during the above-mentioned predetermined time.

In all of those control procedures, the speed of the hand of the avatar object 6B is set to a speed that is slow enough that the user 5A is unlikely to feel a sense of strangeness. The reason for setting to such a speed is that when the movement speed of the hand of the avatar object 6B is a speed that is impossible in a real space, the user 5A may feel strange about the motion of the hand of the avatar object 6B, which may prevent the user 5A from concentrating on communication to/from the user 5B.

[Flow of Processing in Computer]

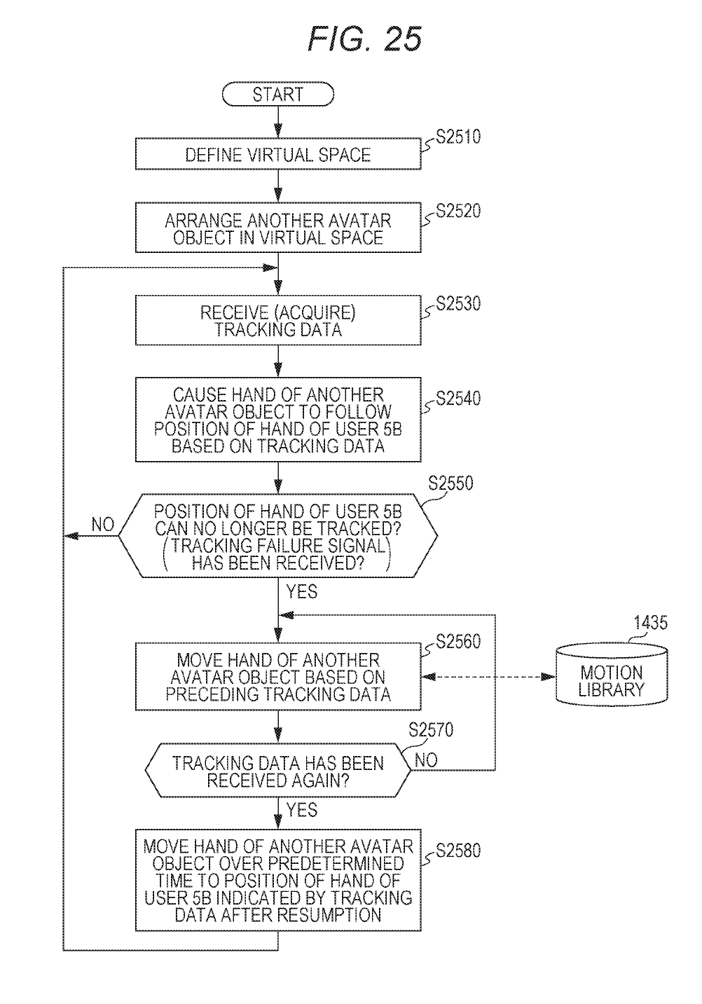

The computer processing to be executed when the position of the hand of the user is no longer tracked is now described with reference to FIG. 25. FIG. 25 is a flowchart of processing to be executed when the computer 200A is no longer tracks the position of the hand of the user 5B according to at least one embodiment of this disclosure. The processing in FIG. 25 may be implemented by the processor 210 of the computer 200 executing a control program stored in the memory 220A or the storage 230A.

In Step S2510, the processor 210A defines the virtual space 11 based on the virtual space designation information 1954 received from the server 600.

In Step S2520, the processor 210A arranges the avatar object 6B in the virtual space 11A based on the information on the avatar object 6B received from the computer 200B via the server 600.

In Step S2530, the processor 210A receives from the computer 200B via the server 600 tracking data for tracking the position of the hand (position of joint j) of the user 5B. This tracking data is based on the output of the first camera 150B connected to the computer 200B.

In Step S2540, the processor 210A causes the hand of the avatar object 6B to follow the position of the hand of the user 5B based on the received tracking data. In other words, the processor 210A causes the hand of the avatar object 6B to follow the position indicated by the received tracking data.

In Step S2550, the processor 210A determines whether the position of the hand of the user 5B is no longer tracked. As an example, the processor 210A determines that the position of the hand of the user 5B is no longer tracked when the tracking failure signal has been received from the computer 200B via the server 600.

In response to a determination that the position of the hand of the user 5B is no longer tracked (YES in Step S2550), the processor 210A advances the processing to Step S2560. On the other hand, in response to a determination that the position of the hand of the user 5B is tracked (NO in Step S2550), the processor 210A returns the processing to Step S2530.

In Step S2560, the processor 210A refers to the motion library 1435 and identifies the motion corresponding to the position indicated by the preceding tracking data. The processor 210A moves the hand of the avatar object 6B in accordance with the identified motion.

In Step S2570, the processor 210A determines whether the tracking data has been received again from the computer 200B via the server 600. In response to a determination that the tracking data has been received again (YES in Step S2570), the processor 210A advances the processing to Step S2580. On the other hand, in response to a determination that the tracking data has not been received again (NO in Step S2570), the processor 210A returns the processing to Step S2560.

In Step S2580, the processor 210A moves the hand of the avatar object 6B over a predetermined time to the position of the hand of the user 5B indicated by the tracking data after resumption. The movement speed of the hand of the avatar object 6B at this time is set to a speed that is slow enough that the user 5A does not feel a sense of strangeness.

In the processing described above, the user 5A recognizes the avatar object 6B performing a natural motion even when the computer 200A is no longer tracking the position of the hand of the user 5B. Therefore, the user 5A is able to continue communication to/from the user 5B without feeling strange about the avatar object 6B.

When the computer 200A resumes tracking the position of the hand of the user 5B, the hand of the avatar object 6B slowly moves to the position of the hand of the user 5B. As a result, the user 5A is able to continue communication to/from the user 5B without feeling strange about the avatar object 6B.

[Other Configurations]

(Method of Moving Another Avatar Object When Tracking Is Stopped)

In at least the example described above, the computer 200 is configured to move, when the hand of the user 5 is no longer tracked, a part (hand) of the avatar object at the position indicated by the preceding tracking data. There is now described a method (control method) of moving another avatar object when the hand of the user 5 is no longer tracked.

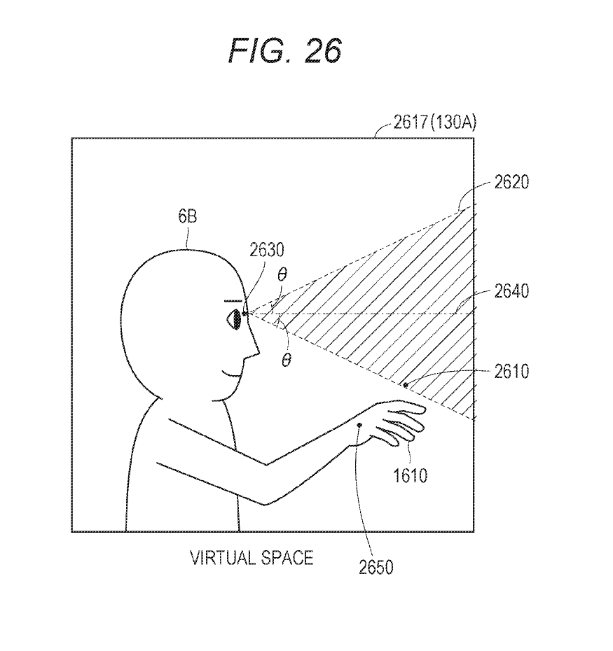

FIG. 26 is a diagram of the motion by the avatar object 6B exhibited when tracking is stopped according to at least one embodiment of this disclosure. In FIG. 26, the user 5A visually recognizes a field-of-view image 2617 displayed on the monitor 130A. In the field-of-view image 2617, the avatar object 6B corresponding to the user 5B is displayed.

In at least one aspect, the computer 200A receives the tracking data indicating a position 2610, and then receives a tracking failure signal. Therefore, the tracking data indicating the position 2610 is the preceding tracking data.

In response to the reception of the tracking failure signal, the processor 210A identifies the range of a field of view 2640 of the user 5B in the virtual space 11A. As at least one example, the processor 210A identifies the range of the field of view 2640 of the user 5B based on a head position 2630 of the avatar object 6B and a reference line of sight 2640. More specifically, as the field of view of the user 5B, the processor 210A identifies a range spreading at an angle θ determined in advance in the direction of the reference line of sight 2640 based on the head position 2630 as a reference.

In at least one aspect, the head position 2630 is set to the position of the eyes of the avatar object 6B. The reference line of sight 2640 can be identified by motion detection data (detection result from sensor 5B) received from the computer 200B via the server 600.

In response to the reception of the tracking failure signal, the processor 210A moves the hand of the avatar object 6B at a position 2150, which is out of the range of the field of view 2140 of the user 5B. At this time, the processor 210A moves the hand of the avatar object 6B in accordance with the motion identified from the motion library 1435 and the preceding tracking data. The position 2650 may be set to a position close to a position 2610 indicated by the preceding tracking data.

When the computer 200A is no longer tracking the position of the hand of the user 5B, the position of the hand of the user 5B in the real space is assumed to be outside the range in which the first camera 150B can acquire the depth information. The first camera 150B is provided to the HMD 120B, and hence the range in which the first camera 150B can acquire the depth information and the field of view of the user 5B are almost the same. Therefore, through movement of the hand of the avatar object 6B outside the field of view of the user 5B when the position of the hand of the user 5B is no longer tracked, the processor 210A is able to bring the position of the hand of the avatar object 6B much closer to the position of the hand of the user 5B in the real space. As a result, the user 5A is able to communicate to/from the user 5B via an avatar object 6B that more accurately reproduces the motion (position) of the user 5B in the real space.

When arranging the avatar object 6B in the virtual space 11B, the computer 200B may arrange the hand of the avatar object 6B outside the field of view of the user 5B in response to the fact that the position of the hand of the user 5B can no longer be tracked. When the hand of the avatar object 6B is included in the field of view of the user 5B during the period in which the computer 200B does not track the position of the hand of the user 5B, the user 5B may feel a sense of strangeness because the position of his or her hand and the position of the hand of the avatar object 6B are different. However, as a result of the computer 200B executing the above-mentioned control, the user 5B does not visually recognize the hand of the avatar object 6B during the period in which the computer 200B does not track the position of the hand of the user 5B. As a result, the above-mentioned control is able to suppress such a sense of strangeness.

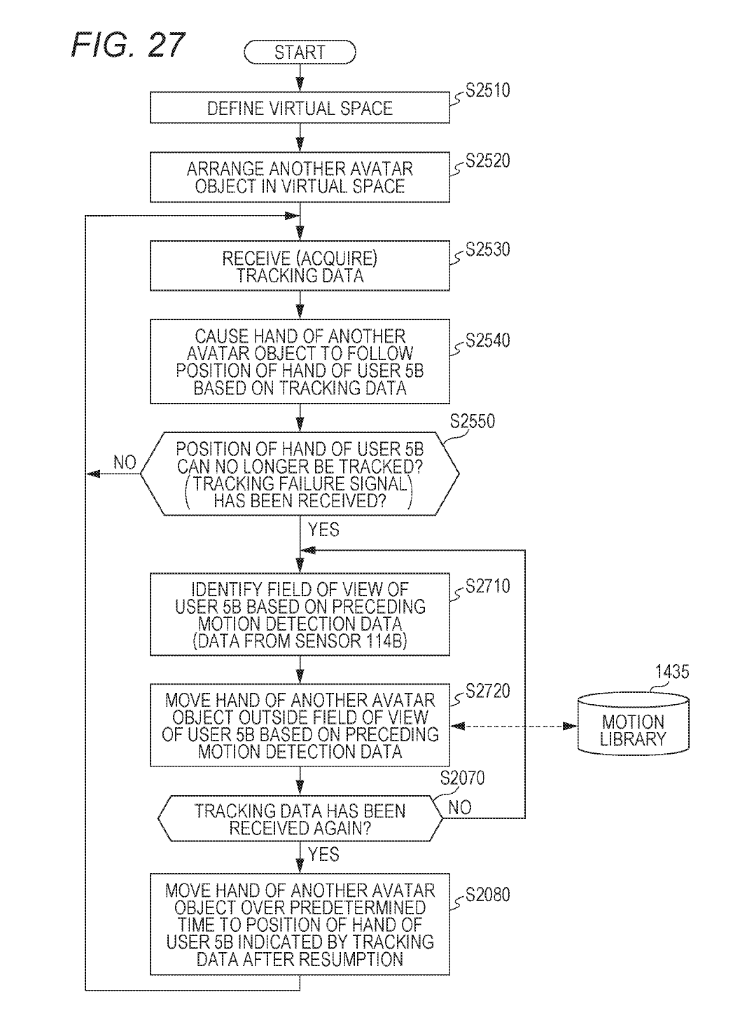

FIG. 27 is a flowchart of processing to be executed when the computer 200A is no longer tracking the position of the hand of the user 5B according to at least one embodiment of this disclosure. The processing in FIG. 27 may be implemented by the processor 210A of the computer 200A executing a control program stored in the memory 220A or the storage 230A. Processing steps of FIG. 27 that are denoted by the same reference symbols as those of FIG. 25 are the same processing steps as those of FIG. 25. Thus, a description of the processing steps is not repeated.

In Step S2710, the processor 210A identifies the field of view of the user 5B based on the motion detection data (detection result from sensor 5B) immediately before the position of the hand of the user 5B is no longer tracked.

In Step S2720, the processor 210A refers to the motion library 1435 and identifies the motion corresponding to the position indicated by the preceding tracking data. The processor 210A moves the hand of the avatar object 6B outside the field of view of the identified user 5B in accordance with the identified motion.

(Method of Moving Another Avatar Object When Tracking Is Stopped)

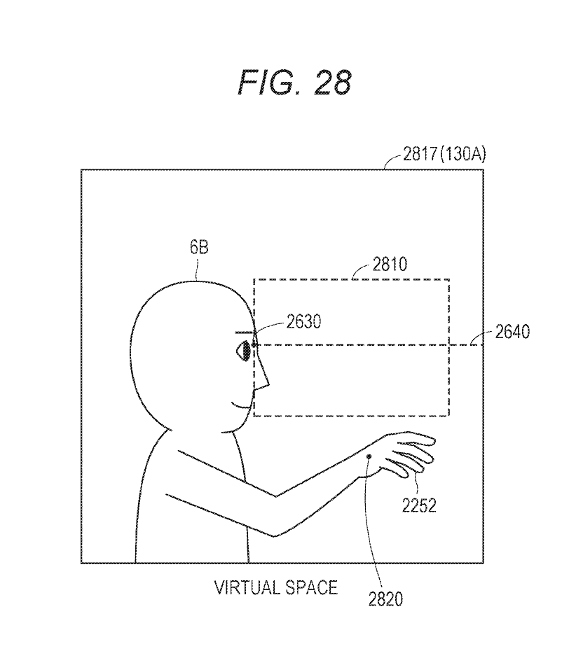

FIG. 28 is a diagram of the motion by the avatar object 6B exhibited when tracking is stopped according to at least one embodiment of this disclosure. In FIG. 28, the user 5A visually recognizes a field-of-view image 1817 displayed on the monitor 130A. In the field-of-view image 1817, the avatar object 6B corresponding to the user 5B is displayed.

In at least one aspect, the processor 210A receives a tracking failure signal from the computer 200B via the server 600. In response to the signal, the processor 210A identifies a spatial region 2810 based on the head position 2630 of the avatar object 6B and the reference line of sight 2640 (i.e., direction of avatar object 6B). As an example, the spatial region 2810 is a rectangular region having a size determined in advance that is set from the head position 2630 toward the reference line of sight 2640.

In response to the reception of the tracking failure signal, the processor 210A moves the hand of the avatar object 6B at a position 2820, which is out of the range of the identified spatial region 2810. Even with such a configuration, the processor 210A is able to more accurately reproduce the motion (position) by the user 5B in the real space when the hand of the user 5B is no longer tracked.

(Method of Moving Another Avatar Object When Tracking Is Stopped)

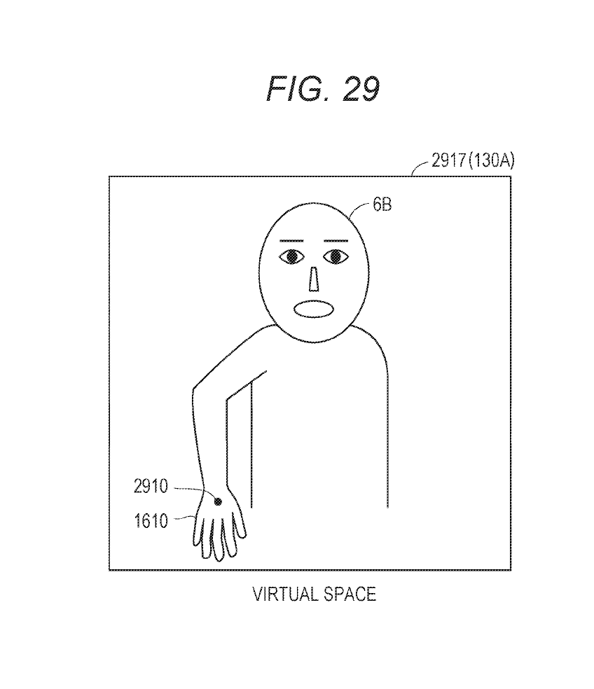

FIG. 29 is a diagram of the motion by the avatar object 6B exhibited when tracking is stopped according to at least one embodiment of this disclosure. In FIG. 29, the user 5A visually recognizes a field-of-view image 2917 displayed on the monitor 130A. In the field-of-view image 2917, the avatar object 6B corresponding to the user 5B is displayed.

In at least one aspect, the processor 210A receives a tracking failure signal from the computer 200B via the server 600. In response, the processor 210A may move the hand of the avatar object 6B to a position 14310 determined in advance. The position 14310 determined in advance is a position relative to the position of the avatar object 6B. Therefore, as a result of moving the hand of the avatar object 6B to the position 2910 determined in advance, the posture of the avatar object 6B changes into a posture determined in advance. The posture determined in advance include, for example, a posture in which the hands are arranged at the sides of a body (at-attention posture).

In accordance with the motion identified by the motion library 1435 and the preceding tracking data, the processor 210A moves the hand of the avatar object 6B to the position 2910 determined in advance.

(Tracking Target Portion)

In at least the example described above, the computer 200 is configured to track the position of the hand of the user 5. In at least one aspect, the computer 200 is configured to track the position of a fingertip of the hand of the user 5, the position of a foot of the user 5, or the position of a part of the body of the user 5.

(Method of Determining that Tracking Is No Stopped)

In at least the example described above, the computer 200 is configured to determine that tracking is no longer possible when a tracking failure signal has been received from another computer 200 via the server 600. In at least one aspect, the computer 200 determines that tracking a part of the body of the user 5 is stopped when the tracking data cannot be received from another computer 200 for a predetermined period (e.g., 10 frames).

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

1-7. (canceled)

8. A method, comprising:
defining a virtual space, the virtual space comprising an avatar object representing a user, wherein the avatar comprises a second portion corresponding to a first portion of a real body of the user;
detecting a position of the first portion in a real space;
moving a position of the second portion to a first position in the virtual space corresponding to the detected position of the first portion in the real space;
detecting movement of the first portion in the real space;
moving the second portion in the virtual space in response to the detected movement of the first portion;
determining whether the position of the first portion in the real space is no longer identifiable;
moving, in response to a determination that the position of the first portion in the real space is no longer identifiable, the second portion;
determining whether detection of the position of the first portion in the real space is resumed; and
moving the position of the second portion to a second position corresponding to a position of the first portion in the real space when detection of the position of the first portion is resumed, wherein the moving of the position of the second portion to the second position over a predetermined time period.

9. The method according to claim 8, wherein the moving the second portion comprises moving, in response to a determination that the position of the first portion in the real space is no longer identifiable, the second portion toward a third position in the virtual space corresponding to a previously detected motion of the first portion in the real space.

10. The method according to claim 9,
wherein the first portion comprises a hand of the user, and
wherein the second portion comprises a hand of the avatar.

11. The method according to claim 9, further comprising:
associating a detected motion of the first portion in the real space with a first motion in the virtual space;
retrieving from a motion library, in response to the determination that the position of the first portion in the real space is no longer identifiable, the first motion based on the previously detected position of the first portion in the real space; and
moving the second portion in accordance with the first motion in response to the determination that the position of the first portion in the real space is no longer identifiable.

12. The method according to claim 9, further comprising:
identifying a field of view of the avatar;
generating an image corresponding to the field of view; and
wherein the third position is located outside the field of view based on a previously detected position of the first portion in the real space.

13. The method according to claim 9, wherein the moving of the position of the second portion to the second position comprises moving the second portion at a speed based on the predetermined time period and a distance between the third position and the second position.

14. The method according to claim 13, wherein the moving of the position of the second portion to the second position comprises:
moving the second portion at the first speed; and
reducing the first speed to a second speed, slower than the first speed, as the second portion approaches the second position.

15. A system comprising:
a non-transitory computer readable medium configured to store a program thereon; and
a processor connected to the non-transitory computer readable medium, wherein the processor is configured to execute the program for:
defining a virtual space;
arranging in the virtual space an avatar object representing a user, wherein the avatar comprises a second portion corresponding to a first portion of a real body of the user;
detecting a position of the first portion in a real space;
moving a position of the second portion to a first position in the virtual space corresponding to the detected position of the first portion in the real space;
determining whether the position of the first portion in the real space is no longer identifiable;
moving, in response to a determination that the position of the first portion in the real space is no longer identifiable, the second portion to a second position in the virtual space corresponding position corresponding to a previously detected position of the first portion in the real space;
determining whether detection of the position of the first portion in the real space is resumed; and
moving the position of the second portion to a third position corresponding position corresponding to a position of the first portion in the real space when detection of the position of the first portion is resumed, wherein the moving of the position of the second portion to the third position occurs at a first speed.

16. The system according to claim 15,
wherein the first portion comprises a hand of the user, and
wherein the second portion comprises a hand of the avatar object.

17. The system according to claim 15, wherein the processor is further configured to execute the program for:
associating the position of the second portion with a first motion;
identifying the first motion associated with the corresponding position based on data acquired prior to the determination that the position of the first portion in the real space is no longer identifiable; and
moving the second portion in accordance with the first motion in response to the determination that the position of the first portion in the real space is no longer identifiable.

18. The system according to claim 15, wherein the processor is further configured to execute the program for:
identifying a field of view of the avatar object;
generating an image corresponding to the field of view; and
moving, in response to the determination that the position of the first portion in the real space is no longer identifiable, the position of the second portion to a fourth position outside the field of view.

19. The system according to claim 18, wherein the processor is further configured to execute the program for:
moving, in response the determination that the position of the first portion in the real space is no longer identifiable, the position of the second portion from the second position to the fourth position.

20. The system according to claim 15, wherein the processor is further configured to execute the program for moving the position of the second portion to the third position at the first speed below a speed determined in advance.

21. The system according to claim 15, wherein the processor is further configured to execute the program for:
initially moving the position of the second portion to the third position at the first speed; and
reducing the first speed to a second speed, slower than the first speed, as the second portion approaches the third position.

22. A method, comprising:
defining a virtual space;
arranging in the virtual space an avatar object representing a user, wherein the avatar object comprises a second portion corresponding to a first portion of a real body of the user;
receiving a signal, wherein in a first state the signal indicates a detected position of the first portion in a real space, and in a second state the signal indicates a failure to detect a position of the first portion in the real space;
moving, in response to the signal in the first state, the second portion to a first position in the virtual space corresponding to the detected position of the first portion in the real space; and
moving, in response to the signal in the second state, the second portion to a second position in the virtual space.

23. The method according to claim 22, wherein the moving of the second portion to the second position comprises moving the second portion out of a field of view of the avatar object.

24. The method according to claim 22, wherein the moving of the second portion to the second position comprises moving the second portion to the second position based on a detected position of the first portion at a last signal in the first state.

25. The method according to claim 22, wherein the moving of the second portion to the second position comprises moving the second portion at a speed below a speed determined in advance.

26. The method according to claim 22, wherein the moving of the second portion to the second position comprises:
initially moving the second portion at a first speed; and
reducing the first speed to a second speed as the second portion approaches the second position.

27. The method according to claim 22, further comprising:
receiving the signal in the first state after receiving the signal in the second state;
moving, in response to receiving the signal in the first state after receiving the signal in the second state, the second portion from the second position to the first position.
